(19) United States
(12) Patent Application Publication
(10) Pub. No.: US 2022/0316261 A1
(43) Pub. Date: Oct. 6, 2022

(54) VEHICLE CLOSURE ASSEMBLY ACTUATING METHOD AND SYSTEM

(71) Applicant: Ford Global Technologies, LLC, Dearborn, MI (US)

(72) Inventors: Stuart C. Salter, White Lake, MI (US); Adrian Nania, Rochester, MI (US); Annette Lynn Huebner, Highland, MI (US); Paul Kenneth Dellock, Northville, MI (US); Sarah A. Ripley, Beverly Hills, MI (US); Marguerite Kimball, Brighton, MI (US); David Brian Glickman, Southfield, MI (US)

(21) Appl. No.: 17/216,834

(22) Filed: Mar. 30, 2021

(51) Int. Cl. E05F 15/76

(52) U.S. Cl. CPC E05F 15/76; E05F 2015/767

(57) ABSTRACT

A vehicle closure assembly actuating method includes, among other things, detecting a user approaching the vehicle, and assessing an approach speed of the user. The approach speed is a speed at which the user is approaching the vehicle. The method further includes opening a closure assembly of the vehicle based, at least in part, on the approach speed from the assessing.

### TECHNICAL FIELD

This disclosure relates generally to a closure assembly for a vehicle and, more particularly, to automatically opening the closure assembly when a user that is transporting a heavy load approaches the vehicle.

### BACKGROUND

Vehicles include closure assemblies, such as side doors and tailgate assemblies. Some vehicles include a tailgate assembly having include a tailgate door. Some closure assemblies are configured to open automatically in response to a user pressing a button on a keyfob or making a particular gesture.

### SUMMARY

A vehicle closure assembly actuating method according to an exemplary aspect of the present disclosure includes, among other things, detecting a user approaching the vehicle, and assessing an approach speed of the user. The approach speed is a speed at which the user is approaching the vehicle. The method further includes opening a closure assembly of the vehicle based, at least in part, on the approach speed from the assessing.

Another example of the foregoing method includes assessing whether or not the user is transporting a load and opening the closure assembly based further on an assessment that the user is transporting the load.

Another example of any of the foregoing methods includes comparing the approach speed of the user to a threshold speed and, if the approach speed is less than the threshold speed, opening the closure assembly.

Another example of any of the foregoing methods includes identifying the user approaching the vehicle based in at least part on a keyfob.

Another example of any of the foregoing methods includes identifying the user approaching the vehicle based at least in part on facial recognition.

Another example of any of the foregoing methods comparing the approach speed of the user to a threshold speed and, if the approach speed is less than threshold speed, opening the closure assembly.

Another example of any of the foregoing methods includes selecting the threshold speed based, at least in part, on an identity of the user.

In another example of any of the foregoing methods, the threshold speed is fifteen-percent less than an average approach speed for the user.

Another example of any of the foregoing methods includes assessing the approach speed using at least one radar sensor of the vehicle.

Another example of any of the foregoing methods includes adjusting the threshold speed based on a slope.

In another example of any of the foregoing methods, the closure assembly is a tailgate assembly.

In another example of any of the foregoing methods, the closure assembly is a tailgate door.

Another example of any of the foregoing methods includes opening the closure assembly based further on an assessment of whether or not the vehicle is located in a stopping zone.

Another example of any of the foregoing methods includes opening the closure assembly based on recognition of a cart being moved by the user.

A vehicle closure assembly actuation system according to another exemplary aspect of the present disclosure includes, among other things, a closure assembly, an actuator that moves the closure assembly from a closed position to an open position, a detector system configured to detect a user approaching the vehicle, and a detector system configured to assess an approach speed of the user. An approach speed is the speed at which the user is approaching the vehicle. The system further includes a control module that, when the user approaching the vehicle is detected, opens a closure assembly of the vehicle based, at least in part, on the approach speed.

In another example of the foregoing system, the closure assembly is a tailgate.

In another example of any of the foregoing systems, the closure assembly is a tailgate door.

In another example of any of the foregoing systems, the detector system includes a radar system.

In another example of any of the foregoing systems, the control module opens the closure assembly of the vehicle based additionally at least in part whether or not the user is transporting a load.

Another example of any of the foregoing systems includes comparing the approach speed of the vehicle to a threshold speed and, if the approach speed is less than the threshold speed, opening the enclosure assembly.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 shows the top view of a vehicle according to an exemplary aspect of the present disclosure. The vehicle includes a vehicle closure assembly actuating system.

FIG. 2 shows a closure assembly of the vehicle, here a tailgate door in a closed position.

FIG. 3 shows a perspective view of a user positioning a load within a cargo area of the vehicle when the tailgate door is in an open position.

FIG. 4 shows a top view of vehicle when the tailgate door in an open position.

FIG. 5 shows a flow of a method utilized by a control module of the vehicle for opening the closure assembly of FIGS. 1-4.

### DETAILED DESCRIPTION

This disclosure details exemplary methods of automatically opening a closure assembly of a vehicle, such as tailgate door.

The closure assembly can be automatically opened when a user transporting a load approaches the vehicle at a relatively slow speed. This can indicate that the user is likely transporting a relatively heavy load. Automatically opening the closure assembly then provides an opening for the user to place the load within the vehicle.

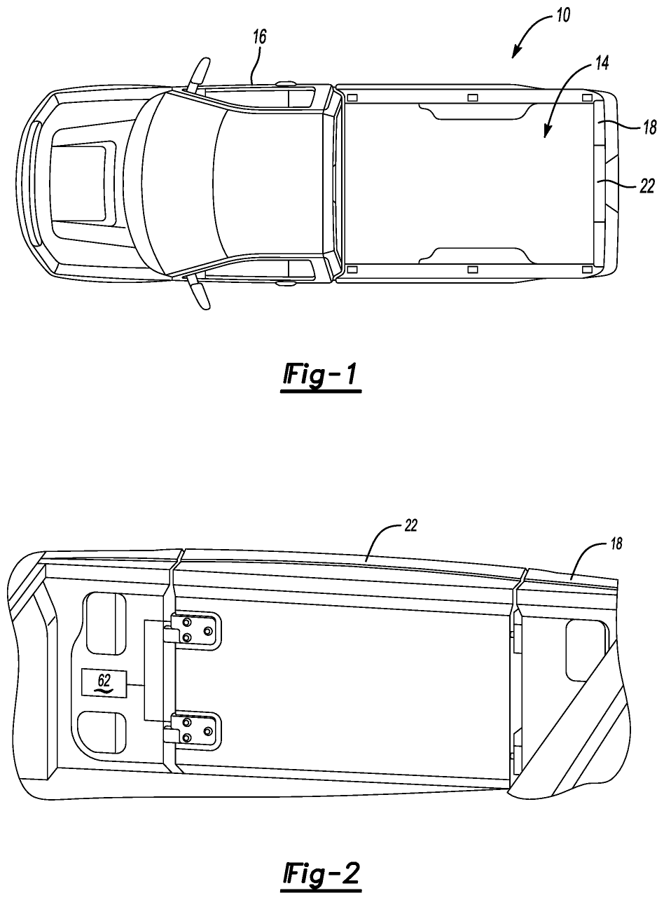

With reference to FIG. 1, a vehicle 10 has a cargo area 14. The vehicle 10 is a pickup truck in this example, and a cargo bed of the vehicle 10 provides the cargo area 14. The vehicle 10 of the exemplary embodiment includes various closure assemblies, including side doors 16, a tailgate assembly 18, and a tailgate door 22.

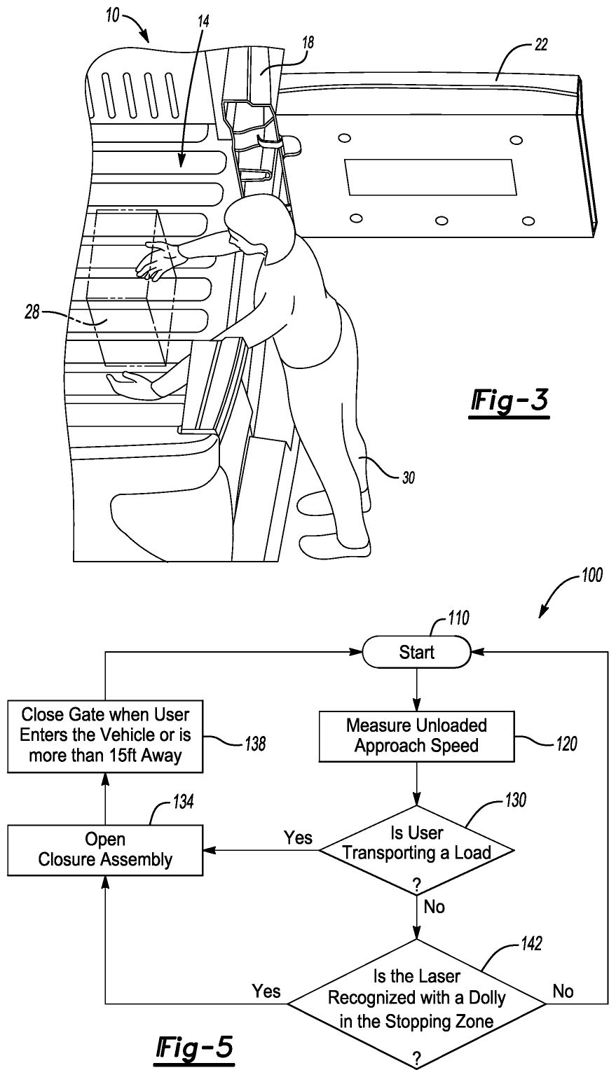

The tailgate assembly 18 encloses an aft end of the cargo area 14 when the tailgate assembly 18 is in the closed position of FIG. 1. With reference to FIGS. 2 and 3, the tailgate assembly 18 includes the tailgate door 22, which can be moved from the closed position of FIG. 2 to the open position of FIG. 3. The tailgate door 22 in the open position enables a user 30 to position a load 28 within the cargo area 14 of the vehicle 10.

In the exemplary embodiment, the tailgate door 22 pivots automatically from the closed position to the open position when a user 30 is transporting the load 28, and a speed at which the user 30 is approaching the vehicle 10 is less than a threshold speed.

An approach speed for the user 30 that is less than the threshold speed indicates that the load 28 is relatively heavy—at least heavy enough to substantially reduce the approach speed of the user 30. The heavier load is likely destined for the cargo area 14. Opening the tailgate door 22 provides an opening that the user can utilize to position the load 28 within the cargo area 14. If the user 30 were instead carrying a relatively light load, the user 30 would approach the vehicle 10 at close to the normal approach speed of the user 30. The relatively light load is interpreted as being destined for an area of the vehicle 10 other than the cargo area 14.

In a particular embodiment, the threshold speed is fifteen-percent less than an average approach speed (average walking speed) for the user 30. An approach speed of fifteen-percent or less than the average approach speed indicates that the load 28 is relatively heavy.

In an exemplary embodiment, the vehicle 10 includes a detector system that has cameras 50 and radar sensors 54 that are operatively connected to a control module 58. Known detector systems can detect whether or not a user is carrying a load.

The control module 58 can use data collected from the cameras 50 and radar sensors 54 to, among other things, assess whether the user 30 is approaching the vehicle 10, to identify the user 30, to assess an approach speed of the user 30, and to assess whether or not the user 30 is transporting a load.

The control module 58, in this exemplary embodiment, includes a processor and a memory portion. The control module 58 can be a stand-alone controller or incorporated into another control module of the vehicle 10. Although schematically shown as a single hardware device, the control module 58 could include multiple control modules in the form of multiple hardware devices, or multiple software controllers within one or more hardware devices. At least some portions of the control module 58 could, in some examples, be located remote from the vehicle 10.

The processor of the control module 58 can be programmed to execute a program stored in the memory portion. The processor can be a custom made or commercially available processor, a central processing unit (CPU), an auxiliary processor among several processors associated with the control module 58, a semiconductor-based microprocessor (in the form of a microchip or chip set) or generally any device for executing software instructions.

The program can be stored in the memory portion as software code. The memory portion can include any one or combination of volatile memory elements and/or nonvolatile memory elements. The program stored in the memory portion can include one or more additional or separate programs, each of which includes an ordered listing of executable instructions for implementing logical functions associated with controlling the cameras 50 and the radar sensors 54.

The control module 58 can receive data from the cameras 50 and the radar sensors 54, which can continually monitor areas surrounding the vehicle 10 even when the vehicle 10 is parked as shown. Information from the cameras 50 and the radar sensors 54 can indicate to the control module 58 that the user 30 is approaching the vehicle 10. Information from the cameras 50 and the radar sensors 54 can additionally indicate an approach speed of the user 30 toward the vehicle 10.

In some examples, the cameras 50 and radar sensors 54 are activated in response to the vehicle 10 detecting the user 30 approaching the vehicle 10. The detection can be based on a keyfob 60 held by the user 30 approaching the vehicle 10, which indicates that the user 30 is approaching the vehicle 10.

The detecting of the user 30 approaching the vehicle 10 triggers the control module 58 to obtain information from the cameras 50 and radar sensors 54 so that the control module 58 can assess the approach speed of the user 30 approaching the vehicle 10.

Based at least in part on the approach speed of the user 30, the control module 58 can activate an actuator 62 to open the tailgate door 22. The actuator 62 can be a servomotor that drives powered hinges, for example.

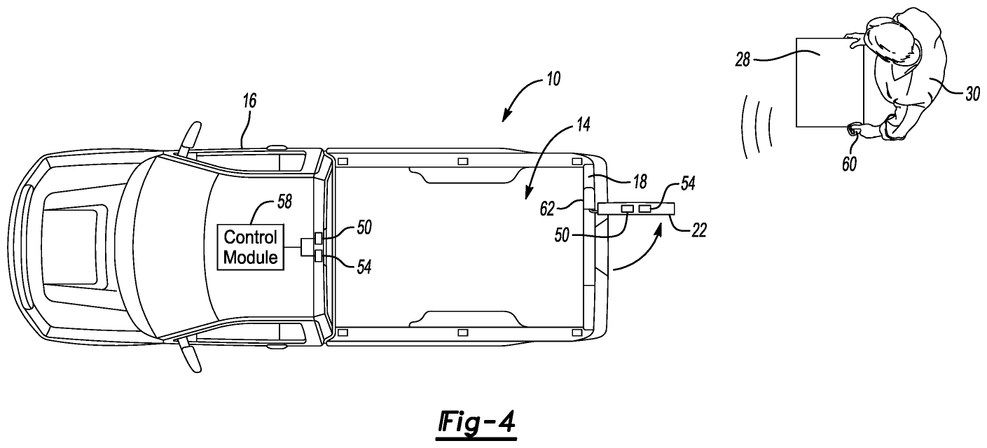

In FIG. 4, the control module 58 associates the keyfob 60 with a particular user 30. The control module 58 can identify the user 30 approaching the vehicle 10 based on the keyfob 60 approaching the vehicle 10.

In the exemplary embodiment, the user 30, when not transporting a heavy load, has an average approach speed that is from 1.34 to 1.36 meters-per-second. The average approach speed for the user 30, and other users, can be stored in a lookup table within a memory portion that is accessible by the control module 58.

When the user 30 is transporting a relatively heavy load, the actual approach speed for the user drops by fifteen-percent or more. The control module 58 compares the actual approach speed of the user 30 to the average approach speed for the user 30. In so doing, the control module 58 assesses whether or not the user is transporting a relatively heavy load.

In FIG. 4, the control module 58 has commanded the actuator 62 to open the tailgate door 22 since the control module 58 has received information indicating that the user 30 is approaching the vehicle 10 with the load 28, and the approach speed for the user 30 is fifteen-percent less than the average approach speed for the user 30. Opening the tailgate door 22 provides a location for the user to place the load 38 within the cargo area 14 as shown in FIG. 3.

The control module 58 relies on the keyfob 60 to identify the user 30, in this example. In another example, the camera 50 could detect a face of the user 30 and, using facial recognition software and techniques, use the face to identify the user 30.

Identifying the user 30 enables the control module 58 to select an average (unloaded) approach speed associated with that user 30. The control module 58 can then assign a threshold speed at an amount that is, say, fifteen-percent less than the average approach speed for that user.

In some examples, the camera 50 and radar sensors 54 also reveal terrain around the vehicle 10. If the user 30 is climbing a steep slope when approaching the vehicle 10, the control module 58 may incorporate an adjustment factor to account for the steep slope slowing the approach speed. That is, the threshold speed triggering the control module 58 to command the actuator 62 to open the tailgate door 22 can be adjusted based on a slope around the vehicle 10. If the slope is, say twenty-degrees, the approach speed triggering the control module 58 to actuate the actuator 62 may be lower than if the slope was only one or two degrees.

The opening of the tailgate door 22 by the control module through the actuator 62 may be further based on a location of the vehicle 10. For example, the vehicle 10 being located in a home improvement store parking lot may trigger the control module 58 to execute the method of opening the tailgate door 22 as described above. Since the home improvement sort is in area where the user 30 is likely return to the vehicle 10 transporting heavy goods, executing the method of opening the tailgate door 22 can be beneficial.

In some examples, the control module 58 utilizes global position system (GPS) coordinates to assess a location of the vehicle 10. The areas that the vehicle 10 can be located in and trigger the control module 58 to actuate the actuator 62 are referred to as a stopping zone in this example.

If the vehicle 10 is at another location that does not commonly result in the user 30 returning to the vehicle 10 transporting goods or loads, the control module 58 may not execute the method described above for opening the tailgate door 22. In some examples, a user can define particular geographic areas as stopping zones. A jobsite may be defined as a stopping zone, for example.

With reference now to FIG. 5 and continuing reference to FIG. 4, a flow of an example method 100 of actuating the vehicle closure assembly begins at a step 110. The method 100 then moves to a step 120 which measures an approach speed of the user toward the vehicle 10 when the user is not transporting a load. The approach speed for the user that is not transporting the load can be measured ten times and then stored within memory as an average approach speed for that user.

The method 100 then moves from the step 120 to a step 130, which assesses whether the user is transporting a load by comparing an actual approach speed of the user to a threshold value, which can be fifteen percent less than the average of the approach speeds.

If the user is transporting a load and an approach speed of the user has decreased significantly, the method 100 moves to the step 134, which opens a closure assembly. In this example, the method 100 activates an actuator to open the closure assembly.

From the step 134, the method 100 moves to the step 138 where the closure assembly is closed when the user detected as entering a passenger compartment of the vehicle, or has moved more than a fixed amount from the vehicle 10, say fifteen feet from the vehicle 10. From the step 138, the method 100 moves back to the step 110.

If, at the step 130, the user is not transporting a load and the approach speed of the user has not decreased, the method moves to a step 142 which assesses whether or not the user is moving a cart (e.g., dolly) and whether or not the vehicle is in a stopping zone. The If, at the step 142, the user is recognized as moving a cart, the method moves to the step 134. If, at the step 142, the user is not recognized with a dolly or is not within the stopping zone, the method 100 returns to the start 110. If, at the step 142, the user is recognized with the dolly and is within the stopping zone, the method 100 moves to the step 134 and opens the closure assembly.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A vehicle closure assembly actuating method, comprising:
detecting a user approaching a vehicle;
assessing an approach speed of the user, the approach speed is a speed at which the user is approaching the vehicle; and
opening a closure assembly of the vehicle based, at least in part, on the approach speed from the assessing.

2. The method of claim 1, further comprising assessing whether or not the user is transporting a load and, opening the closure assembly based further on an assessment that the user is transporting the load.

3. The method of claim 2, further comprising comparing the approach speed of the user to a threshold speed and, if the approach speed is less than the threshold speed, opening the closure assembly.

4. The method of claim 1, further comprising identifying the user approaching the vehicle based at least in part, on a keyfob.

5. The method of claim 1, further comprising identifying the user approaching the vehicle based at least in part on facial recognition.

6. The method of claim 1, further comprising comparing the approach speed of the user to a threshold speed and, if the approach speed is less than the threshold speed, opening the closure assembly.

7. The method of claim 6, further comprising selecting the threshold speed based, at least in part, on an identity of the user.

8. The method of claim 6, wherein the threshold speed is fifteen percent less than an average approach speed for the user.

9. The method of claim 8, further comprising assessing the approach speed using at least one radar sensor of the vehicle.

10. The method of claim 8, further comprising adjusting the threshold speed based on a slope.

11. The method of claim 1, wherein the closure assembly is a tailgate.

12. The method of claim 1, wherein the closure assembly is a tailgate door.

13. The method of claim 1, further comprising opening the closure assembly based further on an assessment of whether or not the vehicle is located in a stopping zone.

14. The method of claim 1, further comprising opening the closure assembly based further on recognition of a cart being moved by the user.

15. A vehicle closure assembly actuating system, comprising:
a closure assembly;
an actuator that moves the closure assembly from a closed position to an open position;
a detector system configured to detect a user approaching a vehicle;
a detector system configured to assess an approach speed of the user, the approach speed a speed at which the user is approaching the vehicle; and
a control module that, when the user approaching the vehicle is detected, opens a closure assembly of the vehicle based, at least in part, on the approach speed.

16. The vehicle closure assembly actuating system of claim 15, wherein the closure assembly is a tailgate.

17. The vehicle closure assembly actuating system of claim 15, wherein the closure assembly is a tailgate door.

18. The vehicle closure assembly actuating system of claim 15, wherein the detector system comprises a radar sensor.

19. The vehicle closure assembly actuating system of claim 15, wherein the control module opens the closure assembly of the vehicle based additionally at least in part on whether or not the user is transporting a load.

20. The vehicle closure assembly actuating system of claim 15, further comprising comparing the approach speed of the user to a threshold speed and, if the approach speed is less than the threshold speed, opening the closure assembly.
